(19) United States
(12) Patent Application Publication
(10) Pub. No.: US 2020/0182366 A1
(43) Pub. Date: Jun. 11, 2020

(54) VENTING VALVE

(71) Applicant: GOODRICH CORPORATION, Charlotte, NC (US)

(72) Inventors: Timothy C. Haynes, Prescott Valley, AZ (US); Michael A. Luzader, Laveen, AZ (US)

(73) Assignee: GOODRICH CORPORATION, Charlotte, NC (US)

(21) Appl. No.: 16/213,438

(22) Filed: Dec. 7, 2018

(51) Int. Cl. F16K 24/04

(52) U.S. Cl. CPC F16K 24/048

(57) ABSTRACT

A venting valve may comprise a valve core sleeve, a valve core piston extending through the valve core sleeve, a spring member coupled between the valve core sleeve and the valve core piston, and a gasket coupled to the valve core piston, wherein the spring member biases the venting valve towards an open position. A compressed fluid may act against the bias of the spring member to move the venting valve to a closed position during an inflation event.

### FIELD

The present disclosure is directed to valves, and more particularly to air valves for inflatable apparatus.

### BACKGROUND

Air valves are used for inflatable apparatus. In their neutral state, air valves are typically secured in a closed position to prevent air from leaking from the inflatable apparatus.

Inflatable devices may be stowed in a deflated state until they are ready for use, at which time they may be inflated. While stowed, the inflatable devices may experience changes in ambient pressure. In this regard, the internal volume of the inflatable devices may vary based upon the external ambient pressure.

### SUMMARY

A venting valve is disclosed, comprising a valve core sleeve, a valve core piston extending through the valve core sleeve, a spring member coupled between the valve core sleeve and the valve core piston, and a gasket coupled to the valve core piston, wherein the spring member biases the venting valve towards an open position.

In various embodiments, the gasket is spaced apart from the valve core sleeve in the open position.

In various embodiments, the valve core piston moves with respect to the valve core sleeve against the bias of the spring member to a closed position.

In various embodiments, the gasket contacts the valve core sleeve in response to the valve core piston moving to the closed position.

In various embodiments, the venting valve further comprises a valve body surrounding the valve core sleeve.

In various embodiments, the venting valve further comprises a piston head coupled to an end of the valve core piston, wherein the piston head abuts the valve core sleeve in the open position.

In various embodiments, the spring member surrounds the valve core piston.

In various embodiments, the spring member and the valve core piston are concentric.

In various embodiments, the venting valve further comprises a first flange extending from an inner surface of the valve core sleeve, wherein the spring member mates against the first flange.

In various embodiments, the venting valve further comprises a second flange extending from the valve core piston, wherein the spring member mates against the second flange.

An inflatable system is disclosed, comprising an inflatable apparatus and a venting valve in fluid communication with the inflatable apparatus. The venting valve comprises a valve core sleeve, a valve core piston extending through the valve core sleeve, a spring member coupled between the valve core sleeve and the valve core piston, and a gasket coupled to the valve core piston, wherein the spring member biases the venting valve towards an open position.

In various embodiments, the venting valve allows fluid to travel freely between the inflatable apparatus and an ambient gas in the open position.

In various embodiments, the inflatable system further comprises an inlet coupled to the inflatable apparatus whereby the inflatable apparatus receives a compressed fluid, wherein the venting valve moves to a closed position in response to the compressed fluid being received by the inflatable apparatus.

In various embodiments, a force generated by the compressed fluid moves the valve core piston with respect to the valve core sleeve, against the bias of the spring member, to the closed position.

In various embodiments, the gasket is spaced apart from the valve core sleeve in the open position and the gasket contacts the valve core sleeve in response to the valve core piston moving to a closed position.

In various embodiments, the inflatable system further comprises a valve body surrounding the valve core sleeve.

In various embodiments, the spring member surrounds the valve core piston and the spring member and the valve core piston are concentric.

In various embodiments, the inflatable system further comprises a first flange extending from an inner surface of the valve core sleeve, wherein the spring member mates against the first flange.

In various embodiments, the inflatable system further comprises a second flange extending from the valve core piston, wherein the spring member mates against the second flange.

A method for manufacturing a venting valve is disclosed, comprising coupling a spring member between a valve core sleeve and a valve core piston, the spring member biases a gasket away from the valve core sleeve in an open position.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1A and FIG. 1B illustrate a section view of a venting valve, in accordance with various embodiments;

FIG. 2 illustrates an exploded view of the venting valve, in accordance with various embodiments;

FIG. 3A and FIG. 3B illustrate a schematic, section view of an inflatable system comprising a venting valve in an open position and a closed position, respectively, in accordance with various embodiments; and

FIG. 4 illustrates a method for manufacturing a venting valve, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact. Cross hatching lines may be used throughout the figures to denote different parts but not necessarily to denote the same or different materials.

An aircraft may include an inflatable evacuation device defining an internal volume. The inflatable evacuation device is stored onboard the aircraft and may be used during an evacuation event. While stored onboard the aircraft, the inflatable evacuation device may experience variations in ambient pressure which may affect the pressure of any fluid disposed within the internal volume of the inflatable evacuation device. A decrease in ambient pressure may cause the internal volume of the inflatable evacuation device to increase which may lead to undesirable events, such as over-pressurization of the storage compartment which contains the inflatable evacuation device and/or premature deployment of the inflatable evacuation device. Having described an inflatable apparatus in the context of aircraft, it is understood that the venting valve of the present disclosure may be used for any inflatable apparatus where venting of the inflatable apparatus is desired prior to inflation of the inflatable apparatus.

A venting valve, as disclosed herein, is in a default-open position to allow an inflatable apparatus to equalize with the ambient air, thereby preventing undesirable inflation of the inflatable evacuation device. The venting valve may also be used to measure the inflatable apparatus internal pressure, for example under testing conditions of the inflatable apparatus.

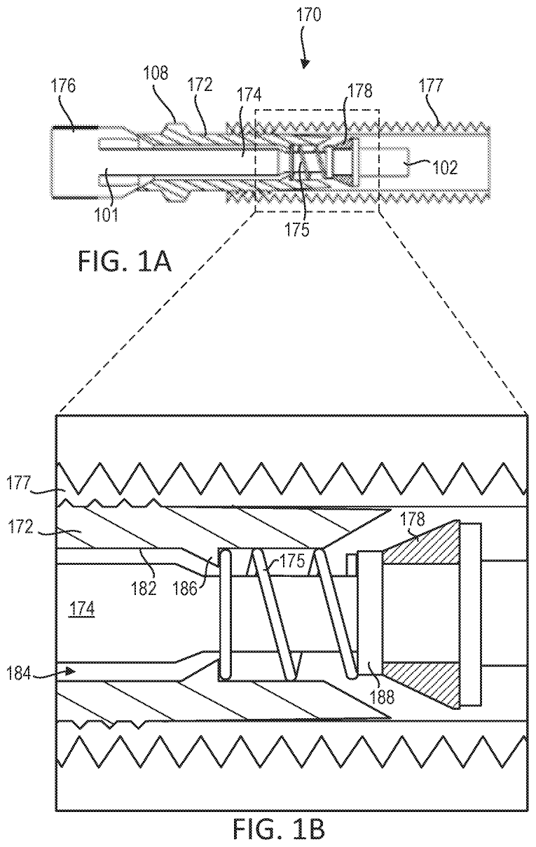

With combined reference to FIG. 1A and FIG. 1B, a valve 170 (also referred to herein as a venting valve) is illustrated, in accordance with various embodiments. Valve 170 is illustrated in a neutral or resting state. Valve 170 is illustrated in an open position. Valve 170 may comprise a valve core sleeve 172 and a valve core piston 174. Valve core piston 174 may be disposed within valve core sleeve 172. Valve core piston 174 may extend through valve core sleeve 172. A piston head 176 may be coupled to a first end 101 of the valve core piston 174 and a gasket 178 may be coupled to a second end 102 of the valve core piston 174. In various embodiments, piston head 176 may be removably coupled to valve core piston 174. In various embodiments, piston head 176 and valve core piston 174 may be manufactured as a single, monolithic piece. In various embodiments, valve 170 may comprise a valve body 177. Valve core sleeve 172 may be received at least partially into valve body 177. Valve core sleeve 172 may be threadingly coupled to valve body 177. Gasket 178 may be disposed within valve body 177. Valve core sleeve 172 may comprise a tab 108 whereby a tool may rotate valve core sleeve 172 with respect to valve body 177 for installation thereto or removal therefrom. Valve 170 may comprise a spring member 175 coupled between valve core sleeve 172 and valve core piston 174. Spring member 175 may be coupled between gasket 178 and valve core sleeve 172. Spring member 175 may bias gasket 178 away from valve core sleeve 172. Spring member 175 may bias valve core piston 174 towards an open position. Stated differently, spring member 175 may bias valve 170 towards an open position. Spring member 175 may surround valve core piston 174. In various embodiments, spring member 175 may comprise a coil spring surrounding valve core piston 174. In various embodiments, spring member 175 may be disposed at least partially within valve core sleeve 172.

With particular focus on FIG. 1B, valve core sleeve 172 may comprise an inner surface 182 defining a bore 184 wherein valve core piston 174 extends. Valve core sleeve 172 may comprise a flange 186 (also referred to herein as a first flange) extending radially inward from inner surface 182. Spring member 175 may mate against flange 186. Spring member 175 may be at least partially recessed within valve core sleeve 172. Stated differently, at least a portion of spring member 175 may be disposed in bore 184. Spring member 175 may be coupled between valve core piston 174 and flange 186 such that a longitudinal force is transmitted between valve core sleeve 172 and valve core piston 174 via spring member 175. Valve core piston 174 may comprise a flange 188 (also referred to herein as a second flange) extending therefrom whereby spring member 175 mates against valve core piston 174. In various embodiments, gasket 178 mates against flange 188. In this manner, valve 170 is biased to a default-open position.

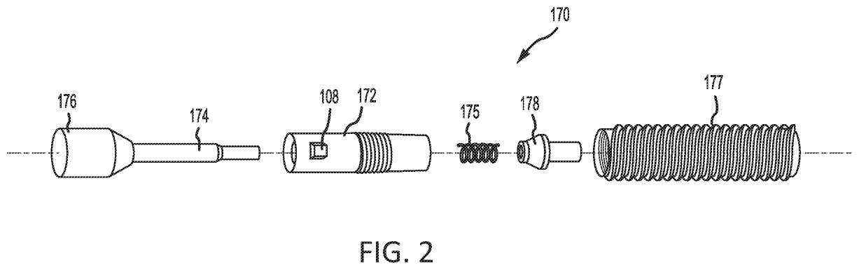

With reference to FIG. 2, an assembly view of valve 170 is illustrated, in accordance with various embodiments. In the installed position, valve core piston 174, valve core sleeve 172, spring member 175, gasket 178, and valve body 177 may be concentric.

With respect to FIG. 7A and FIG. 7B, elements with like element numbering, as depicted in

FIG. 6A and FIG. 6B, are intended to be the same and will not necessarily be repeated for the sake of clarity.

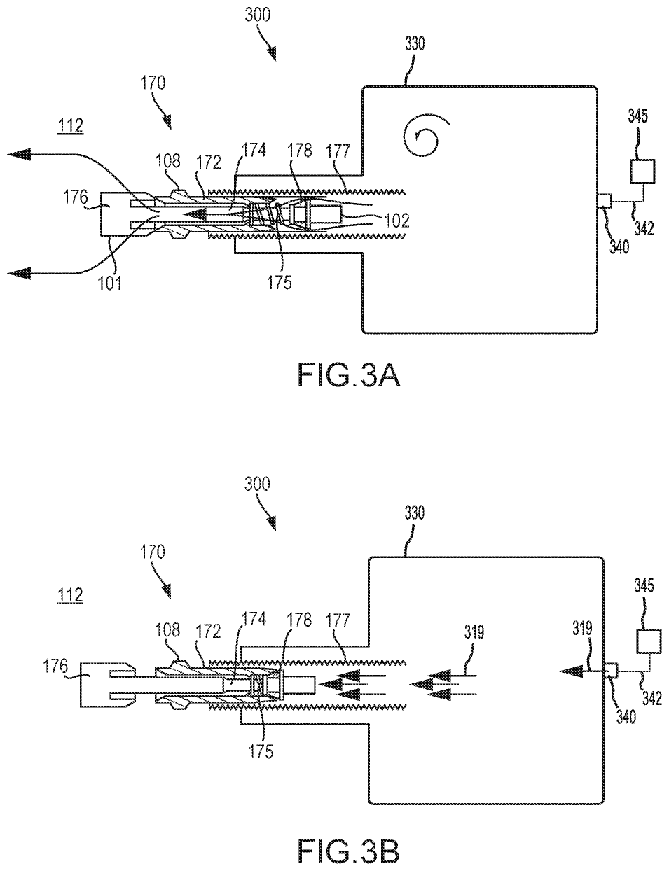

With combined reference to FIG.3A and FIG. 3B, an inflatable system 300 is illustrated, in accordance with various embodiments. Inflatable system 300 includes valve 170 installed onto an inflatable apparatus 330, in accordance with various embodiments. Valve 170 is in fluid communication with inflatable apparatus 330. In various embodiments, inflatable system 300 may further include an inlet 340 coupled to inflatable apparatus 330. A compressed fluid source 345 may be coupled to inlet 340 via a conduit 342. Inflatable apparatus 330 may be inflated by supplying a compressed fluid to inflatable apparatus 330 via inlet 340. In various embodiments, inlet 340, compressed fluid source 345, and/or conduit 342 may incorporate a second valve for controlling the flow of compressed fluid from compressed fluid source 345 to inflatable apparatus 330.

Valve core piston 174 may translate with respect to valve core sleeve 172 between an open position (see FIG. 3A) and a closed position (see FIG. 3B). In the open position, the gasket 178 may be spaced apart from valve core sleeve 172, thereby allowing a fluid to travel from within inflatable apparatus 330, through valve 170, to a location external to inflatable apparatus 330. In this manner, valve 170 may allow a pressure of a fluid within inflatable apparatus 330 to self-equilibrate with ambient gas 112. Stated differently, valve 170 allows fluid to travel freely between inflatable apparatus 330 and the ambient gas 112 in response to valve 170 being in the open position.

In various embodiments, piston head 176 may abut valve core sleeve 172 in response to spring member 175 biasing valve core piston 174 towards the open position, as illustrated in FIG. 3A. Piston head 176 may prevent valve core piston 174 from decoupling from valve core sleeve 172. A subtle increase in pressure of a fluid within inflatable apparatus 330 may be insufficient to transmit a force into valve core piston 174 to cause valve core piston 174 to move to a closed position, such as pressure variations that inflatable apparatus 330 may experience during transit and/or during a flight of an aircraft. However, a substantial increase in pressure of a fluid within inflatable apparatus 330, such as an increase in pressure in response to a compressed fluid 319 flowing from compressed fluid source 345 into inflatable apparatus 330 at a relatively high velocity, may transmit a force into valve core piston 174 which may overcome the bias of spring member 175 and force valve core piston 174 into a closed position, as illustrated in FIG. 3B. Thus, compressed fluid 319 may act upon valve 170 to force valve 170 to the closed position. Stated differently, a force generated by compressed fluid 319 may move valve 170 to the closed position. In this regard, valve 170 may be in an open position in its neutral or resting state and may be moved to the closed position in response to compressed fluid 319 flowing into inflatable apparatus 330.

With reference to FIG. 3B, gasket 178 is compressed against valve core sleeve 172, thereby closing valve 170 and stopping compressed fluid 319 from exiting inflatable apparatus 330. Thus, inflatable apparatus may begin to inflate in response to valve 170 closing. In this regard, spring member 175 biases valve 170 in a default-open position to allow venting of inflatable apparatus 330, and valve 170 is configured to automatically close in response to an inflation event (i.e., in response to a pressurized fluid (e.g., compressed fluid 319) flowing from a compressed fluid source (e.g., compressed fluid source 345) into the inflatable apparatus 330), thereby preventing the compressed fluid 319 from escaping the inflatable apparatus 330. The valve core piston 174 may be held in the closed position as long as the pressure within inflatable apparatus 330 is sufficient enough to overcome the bias of spring member 175.

In various embodiments, inflatable apparatus 330 may comprise any suitable inflatable apparatus. A valve of the present disclosure may be particularly useful for inflatable apparatus which experience variations in ambient pressure which would cause the inflatable apparatus to prematurely inflate, which may cause damage to packaging for the inflatable apparatus. In various embodiments, a valve of the present disclosure may be particularly useful for inflatable apparatus which are stored in a deflated state until the time of use. For example, inflatable apparatus 330 may comprise an inflatable for an aircraft evacuation system. Aircraft typically include a fuselage having plurality of exit doors, with one or more evacuation systems positioned near a corresponding exit door. In the event of an emergency, an exit door may be opened by a passenger or crew member of the aircraft and the evacuation system may deploy in response to the exit door being opened or in response to another action taken by a passenger or crew member such as depression of a button or actuation of a lever. In various embodiments, valve 170 may be used for an aspirator for the inflatable evacuation device. Although an inflatable evacuation system for aircraft is provided as an exemplary application of the valve 170 disclosed herein, it is understood that within the scope of the appended claims, the disclosure may be practiced other than as specifically described.

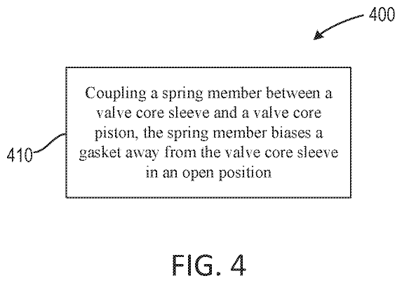

According to various embodiments, and with reference to FIG. 4, a method 400 for manufacturing a venting valve is provided. Method 400 comprises coupling a spring member between a valve core sleeve and a valve core piston, the spring member biases a gasket away from the valve core sleeve in an open position (step 410).

With combined reference to FIG. 1B and FIG. 4, step 410 may include coupling a spring member 175 between valve core sleeve 172 and valve core piston 174, the spring member 175 biases gasket 178 away from valve core sleeve 172 in an open position such that there is a gap between gasket 178 and valve core sleeve 172 whereby fluid may pass through valve 170.

Gasket 178 may be comprised of a rubber material, such as an elastic polymer or some other suitable material. Valve 170, including valve core sleeve 172, valve core piston 174, and/or spring member 175 may be comprised of a metallic material, such as aluminum, anodized aluminum, steel, or stainless steel, among others. Valve core sleeve 172 and/or valve core piston 174 may be comprised of a polyamide or other plastic, composite, or other suitable material. Valve 170 may be formed by additive manufacturing, injection molding, composite fabrication, forging, casting, or other suitable process. As used herein, the term “additive manufacturing” encompasses any method or process whereby a three-dimensional object is produced by creation of a substrate or addition of material to an object, such as by addition of successive layers of a material to an object to produce a manufactured product having an increased mass or bulk at the end of the additive manufacturing process than the beginning of the process. A variety of additive manufacturing technologies are commercially available. Such technologies include, for example, fused deposition modeling, polyjet 3D printing, electron beam freeform fabrication, direct metal laser sintering, electron-beam melting, selective laser melting, selective heat sintering, selective laser sintering, stereolithography, multiphoton photopolymerization, digital light processing, and cold spray. These technologies may use a variety of materials as substrates for an additive manufacturing process, including various plastics and polymers, metals and metal alloys, ceramic materials, metal clays, organic materials, and the like. Any method of additive manufacturing and associated compatible materials, whether presently available or yet to be developed, is intended to be included within the scope of the present disclosure.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A venting valve, comprising:
a valve core sleeve comprising a monolithic structure comprising a first sleeve end and a second sleeve end;
a valve core piston extending through the valve core sleeve;
a piston head coupled to the valve core piston;
a spring member coupled between the valve core sleeve and the valve core piston; and
a gasket coupled to the valve core piston;
wherein the spring member biases the venting valve towards an open position.
the piston head abuts the first sleeve end of the valve core sleeve in response to the venting valve moving to the open position, and
the gasket abuts the second sleeve end of the valve core sleeve in response to the venting valve moving to a closed position.

2. The venting valve of claim 1, wherein the gasket is spaced apart from the valve core sleeve in the open position.

3. The venting valve of claim 1, wherein the valve core piston moves with respect to the valve core sleeve against a bias of the spring member to the closed position.

4. The venting valve of claim 3, wherein the gasket contacts the valve core sleeve in response to the valve core piston moving to the closed position.

5. The venting valve of claim 1, further comprising a valve body surrounding at least a portion of the valve core sleeve, wherein the first sleeve end of the valve core sleeve extends from the valve body and the second sleeve end of the valve core sleeve is disposed within the valve body.

6. (canceled)

7. The venting valve of claim 1, wherein the spring member surrounds the valve core piston.

8. The venting valve of claim 7, wherein the spring member and the valve core piston are concentric.

9. The venting valve of claim 1, further comprising a first flange extending from an inner surface of the valve core sleeve, wherein the spring member mates against the first flange.

10. The venting valve of claim 9, further comprising a second flange extending from the valve core piston, wherein the spring member mates against the second flange.

11. An inflatable system, comprising:
an inflatable apparatus; and
a venting valve in fluid communication with the inflatable apparatus, the venting valve comprises:
a valve core sleeve comprising a monolithic structure comprising a first sleeve end and a second sleeve end;
a valve core piston extending through the valve core sleeve;
a piston head coupled to the valve core piston;
a spring member coupled between the valve core sleeve and the valve core piston; and
a gasket coupled to the valve core piston, wherein the spring member biases the venting valve towards an open position,
the piston head abuts the first sleeve end of the valve core sleeve in response to the venting valve moving to the open position, and
the gasket abuts the second sleeve end of the valve core sleeve in response to the venting valve moving to a closed position.

12. The inflatable system of claim 11, wherein the venting valve allows fluid to travel freely between the inflatable apparatus and an ambient gas in the open position.

13. The inflatable system of claim 11, further comprising an inlet coupled to the inflatable apparatus whereby the inflatable apparatus receives a compressed fluid, wherein the venting valve moves to the closed position in response to the compressed fluid being received by the inflatable apparatus.

14. The inflatable system of claim 13, wherein a force generated by the compressed fluid moves the valve core piston with respect to the valve core sleeve, against the bias of the spring member, to the closed position.

15. The inflatable system of claim 11, wherein the gasket is spaced apart from the valve core sleeve in the open position and the gasket contacts the valve core sleeve in response to the valve core piston moving to the closed position.

16. The inflatable system of claim 11, further comprising a valve body surrounding the valve core sleeve.

17. The inflatable system of claim 11, wherein the spring member surrounds the valve core piston and the spring member and the valve core piston are concentric.

18. The inflatable system of claim 11, further comprising a first flange extending from an inner surface of the valve core sleeve, wherein the spring member mates against the first flange.

19. The inflatable system of claim 18, further comprising a second flange extending from the valve core piston, wherein the spring member mates against the second flange.

20. A method for manufacturing a venting valve, comprising:
disposing a valve core piston to extend through a valve core sleeve, wherein the valve core sleeve comprises a monolithic structure comprising a first sleeve end and a second sleeve end;
coupling a spring member between the valve core sleeve and the valve core piston, the spring member biases a gasket away from the valve core sleeve in an open position;
wherein a piston head abuts the first sleeve end of the valve core sleeve in response to the venting valve moving to the open position, and the gasket abuts the second sleeve end of the valve core sleeve in response to the venting valve moving to a closed position.
